(19) United States
(12) Patent Application Publication
(10) Pub. No.: US 2010/0047031 A1
(43) Pub. Date: Feb. 25, 2010

(54) Crankshaft Milling Cutter

(76) Inventor: Berthold Schaupp, Dettenhausen (DE)

Correspondence Address: DRINKER BIDDLE & REATH (DC), 1500 K STREET, N.W., SUITE 1100, WASHINGTON, DC, 20005-1209, US

(21) Appl. No.: 12/309,587

(22) PCT Filed: Jul. 18, 2007
(86) PCT No.: PCT/EP2007/057448

§ 371 Date: Oct. 23, 2009

(30) Foreign Application Priority Data
Jul. 24, 2006 (DE) 10 2006 034 673.4

(51) Int. Cl. B23C 3/06

(52) U.S. Cl. 409/131; 409/234; 407/34

(57) ABSTRACT

The present invention concerns a method of machining bearing journals, with a first step for rough machining and with a second step for fine machining, wherein in the first step the journal is roughed with a crankshaft milling cutter and in the second step the journal is smoothed with a crankshaft milling cutter. To provide a method as well as a milling cutter and an indexable cutting plate for that milling cutter, which make it possible to machine crankshaft journals more quickly, less expensively and at least with the same quality as in the state of the art, it is proposed according to the invention that the fine machining method exclusively comprises the second step which concludes the dimension-changing machining of the bearing journals.

The present invention concerns a method of machining bearing journals, for rough machining with a first step and for fine machining with a second step, wherein in the first step the journal is roughed with a crankshaft milling cutter and in the second step the journal is smoothed with a crankshaft milling cutter.

In addition the invention concerns a milling cutter or a milling cutter segment which are rotatable about a milling cutter axis, for smoothing machining of bearing journals with at least one cutting plate holder wherein the cutting plate holder has a flat surface forming a part of the plate seat and a displaceable wedge for adjusting the radial spacing of the cutting edge of a cutting plate from the axis of rotation of the milling tool, wherein the wedge has an abutment surface, substantially perpendicular to the flat surface, for a side surface of the cutting plate.

Furthermore the present invention concerns an indexable cutting plate for a milling cutter for smooth machining of bearing journals comprising an upper and a lower surface and peripherally extending side surfaces which connect the upper and lower surfaces together, wherein the edges between the upper and lower surfaces respectively and the side surfaces form the cutting edges, wherein the side surfaces form chip faces adjoining the cutting edges.

In the mass production of crankshafts recourse is generally had to forged or cast shafts. In that respect, the term crankshaft is used here and hereinafter to mean quite generally a machine element which converts linear movements into rotating movements or rotating movements into linear movements. These are in particular crankshafts and camshafts of internal combustion engines. The modern engine construction places ever increasing demands on the operational capability and smoothness of running of crankshafts. In addition the costs involved in manufacture are to be reduced.

The cast or forged rough shafts have to be further machined in the region of the bearing journals for the main and crank bearings so that those regions of the shafts satisfy the demands made on them in regard to dimensional accuracy, rotational truth and surface nature. For that purpose, methods of milling machining crankshafts with external milling cutters are known from the state of the art, for example DE 102 18 630 A1. In that case, disc milling cutters of a diameter of for example about 700 mm and with for example up to 300 indexable cutting plates are generally used. In the state of the art the bearing journals are subjected to milling machining in two steps. Firstly rough machining is effected, by rough milling, and then fine machining, by smoothing or finishing milling. To achieve the surface nature required for the bearing journals, the state of the art provides that, after the conclusion of the milling operations, the surfaces of the bearing journals are subjected to finishing grinding so that, to produce each individual journal, a total of three working steps, roughing milling, smoothing milling and grinding, are successively required. As those three machining steps are carried out with entirely different tools and machines, the procedure for machining bearing journals on a crankshaft is time- and cost-intensive.

In comparison the object of the present invention is to provide a method and a milling cutter and an indexable cutting plate for said milling cutter, which make it possible for crankshaft journals to be machined more quickly, less expensively and at least with the same quality as in the state of the art.

In accordance with the present invention therefore there is provided a method of machining bearing journals, with a first step for rough machining and with a second step for fine machining, more specifically in each case by cutting machining by means of defined cutting operations in a milling procedure, wherein in the first step the journal is roughed with a crankshaft milling cutter and in the second step the journal is smoothed with a crankshaft milling cutter, wherein the fine machining method exclusively comprises the second step which concludes the dimension-changing machining of the bearing journals. In that way the process for the production of the bearing journals or the outside surfaces of the journals can be reduced to a single step for fine machining, namely the above-mentioned smoothing milling operation.

In that respect, in accordance with this application, the expression dimension-changing machining is used to denote a machining operation in which material is removed in specifically targeted fashion to achieve a nominal diameter by means of geometrically defined cutting operations, for example by turning, milling or broaching, or by means of geometrically non-defined cutting edges, for example by grinding. In accordance with the definition employed here however, that dimension-changing machining does not embrace those machining procedures which only serve to change the surface nature, for example by coating or blasting. Those machining operations admittedly possibly also alter the dimensions of the workpiece, but those alterations are minimal and generally negligible or, if necessary, they are also taken into account in the cutting machining operation by means of defined cutting procedures. In addition, in those machining operations which are not considered to be dimension-changing here, the change in the dimension is not the aim of the machining operation. In contrast thereto, grinding or filing is viewed as a dimension-changing machining operation which after the smoothing operation is to be deployed in accordance with the invention as the aim thereof is to produce a final dimension by the removal of material, although not by means of defined cutting operations.

In that respect it is particularly desirable if the method according to the invention has precisely two steps, that is to say firstly a roughing milling operation for rough machining of the journals and then a final smoothing milling operation for fine machining of the journals.

In a particularly preferred embodiment of the invention in the second step of smoothing machining of the bearing journals operation is effected with a cutting speed of more than 250 m/min, preferably more than 270 m/min and particularly preferably more than 300 m/min.

In that respect operation is preferably effected with an advance speed of 1000 mm/min to 2000 mm/min, which in a preferred embodiment corresponds to an advance of about 0.2 mm per cut.

To carry out the method, in accordance with the present invention, there is provided a disc milling cutter or disc milling cutter segment which are rotatable about a milling cutter axis, for smoothing machining of bearing journals with at least one cutting plate holder wherein the cutting plate holder has a first flat surface forming a part of the plate seat and a displaceable wedge for adjusting the radial spacing of the main cutting edge of the cutting insert from the milling cutter axis, wherein the wedge has an abutment surface, substantially perpendicular to the flat surface, for a side surface of the cutting plate, and wherein the wedge is movable in a direction substantially parallel to the flat surface.

The milling cutter or the milling cutter segment according to the invention, that is to say for example a cassette with one or more cutting plate holders, which can be fixed to a substantially rotationally symmetrical main body permits fine adjustment of the radial spacing of the active cutting edge of each cutting insert from the axis of rotation of the milling tool.

For that purpose the flat surface of the plate seat is tilted with respect to a tangent to a circle around the milling cutter axis, in the region of an active cutting edge, more specifically in such a way that the portion of that surface, which leads in the direction of rotation, is at a greater spacing from the milling cutter axis than the trailing portion of that surface. The lateral abutment surface for the cutting insert is formed by a wedge which is displaceable in a direction substantially parallel to the flat surface of the plate seat. In dependence on the position of the wedge, the position of the cutting insert changes in the peripheral direction on the flat surface of the plate seat, that is tilted with respect to the tangent, so that the radial spacing of the active cutting edge from the axis of rotation of the milling cutter changes in the event of a movement of the wedge.

In that way the same radial spacing of the cutting edges of the individual cutting inserts from the axis of rotation of the milling cutter can be set for all cutting inserts of a milling cutter or a milling cutter segment. That ensures a high quality in respect of the surface condition of the bearing journals after the smoothing milling operation with an averaged roughness depth of the surface of less than or equal to 3.2 μm, preferably less than or equal to 1.6 μm. In that respect the averaged roughness depth R_{z} is defined in accordance with DIN 4768. As the wedge for fine adjustment of the cutting plate on the milling cutter is displaceable in a direction parallel to the flat surface of the plate seat and thus to the milling cutter axis, each cutting insert of the milling cutter can be equipped, as an indexable cutting plate, with four or more cutting edges, without the wedge coming into engagement with one of the cutting edges and damaging it. For that purpose the cutting insert is supported in a region of a side surface between the non-active upper and lower cutting edges against the abutment surface of the wedge.

In that respect it is desirable if the abutment surface of the wedge in a direction perpendicular to the flat surface of the plate seat and parallel to the milling cutter axis, is of a width of 0.5 mm to 5 mm, preferably 1 mm to 3 mm and particularly preferably being 1.5 mm.

In a particularly preferred embodiment of the invention the cutting plate holder is provided for receiving trapezoidal cutting inserts. In that respect, in a preferred embodiment, the abutment surface of the wedge includes an angle with the axis of rotation of the milling cutter. That included angle is desirably between 1° and 15°, preferably 12°, and a side surface of the milling cutter preferably deviates by double the angle from a perpendicular to the base line of the trapezium.

It is advantageous in that respect if the side surface of the cutting insert, in the installed condition, is not perpendicular to the axis of rotation but is inclined with respect to the perpendicular to the axis of rotation through an angle of between 1° and 3°, preferably through 2°. In that way a clearance angle is formed between the side surface of the cutting insert and the surface of the workpiece.

In a particularly preferred embodiment fine setting permits an adjustment range for the cutting edge of the cutting plate of 0.05 mm. The screw for mounting the wedge is so selected that the milling cutter permits an adjustment of the rotary truth of the milling cutter of less than 0.005 mm.

In a preferred embodiment of the invention two respective cutting plate seats which are adjacent in the peripheral direction are so arranged that they overlap each other considered in the peripheral direction of the milling cutter. That makes it possible to achieve a wide cutting width with a high level of quality in terms of workpiece machining.

In regard to the indexable cutting plate the object of the present invention is also attained in that there is provided an indexable cutting plate for a milling cutter for smoothing machining of bearing journals comprising an upper and a lower surface and peripherally extending side surfaces which connect the upper and lower surfaces together, wherein the edges between the upper and lower surfaces respectively and the side surfaces form the cutting edges, wherein the side surfaces form chip faces adjoining the cutting edges, wherein the chip faces of the upper and lower cutting edges are separated by a land which protrudes with respect to the chip faces, wherein the land forms the lateral contact surface of the cutting insert.

An indexable cutting plate of such a configuration can be equipped with four or more cutting edges as in the installed condition it is supported with the land as a contact surface against the abutment surface of the displaceable wedge of the milling cutter so that the cutting edges of the indexable cutting plate, that are towards that abutment surface, do not come into engagement with the plate seat or the wedge.

A preferred embodiment of the indexable cutting plate according to the invention is one in which the upper and lower surfaces have at least one corner with an angle greater than 90°. If that angle minus 90° corresponds to the angle of the abutment surface of the wedge of the milling cutter with respect to the axis of rotation of the milling cutter, it is possible for the cutting insert to be fixed to the milling cutter in such a way that one of its side surfaces is always perpendicular to the axis of rotation.

In that respect it is particularly desirable if the upper and lower surfaces of the indexable cutting plate are substantially trapezoidal, preferably of an equal-sided trapezoidal configuration. In that way it is possible to provide an indexable cutting plate having four available cutting edges.

In that case the cutting edges are advantageously arranged along the base side or long side and the short side parallel thereto of the trapezium. Accordingly it is desirable if the milling cutter or the milling cutter segment according to the invention have two different types of cutting plate holders, a first which is provided for receiving an indexable cutting plate so that a cutting edge of the base side of the trapezium actively comes into engagement with the workpiece and a second side provided for receiving an indexable cutting plate so that a cutting edge of the short side of the trapezium, that is parallel to the base side, actively comes into engagement with the workpiece. In that way the two long cutting edges of the indexable cutting plate can be used successively in a plate holder of the first type and the two short cutting edges successively in a plate holder of the second type.

In that respect it is advantageous if the edges of the cutting insert, that extend perpendicularly to the base side and to the short side of the trapezium, form secondary cutting edges.

A particularly preferred embodiment of the invention is one in which the surface of the land is outside the plane defined by the cutting edges of a side of the indexable cutting plate. In that respect it is desirable if the surface of the land protrudes with respect to the plane in which the cutting edges of a side of the indexable cutting plate are disposed, by between 0.01 mm and 0.5 mm, preferably by 0.05 mm.

In order to be able to use the cutting insert according to the invention for smoothing machining which replaces the grinding step known from the state of the art, it is desirable if the cutting edges of the indexable cutting plate have a PVD (plasma vapour deposition) Al₂O₃ coating as the cutting material.

Further advantages, features and possible uses of the present invention will be apparent from the description hereinafter of a preferred embodiment and the Figures relating thereto in which:

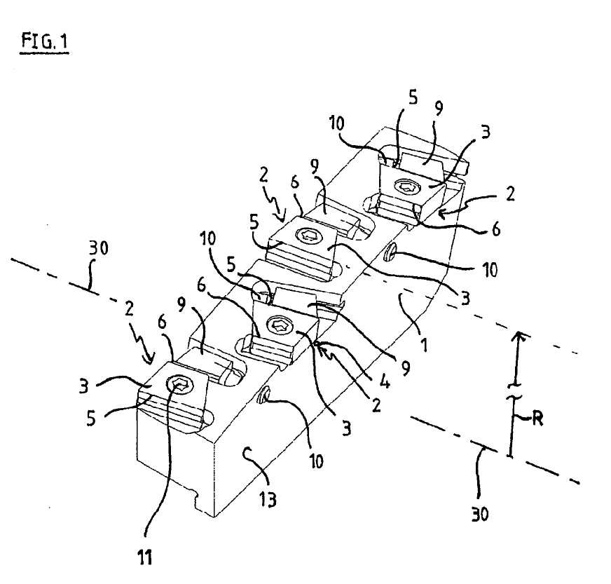

FIG. 1 shows a three-dimensional view of a cassette with cutting inserts of the milling cutter according to the invention,

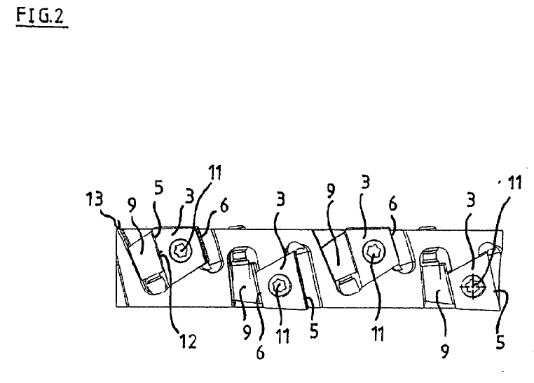

FIG. 2 shows a view from above of the cassette of FIG. 1,

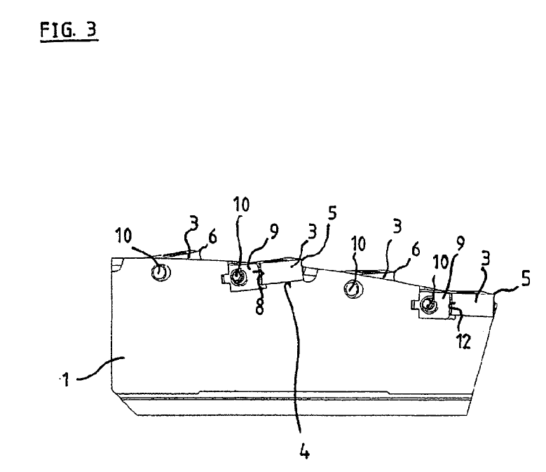

FIG. 3 shows a side view of the cassette of FIG. 1,

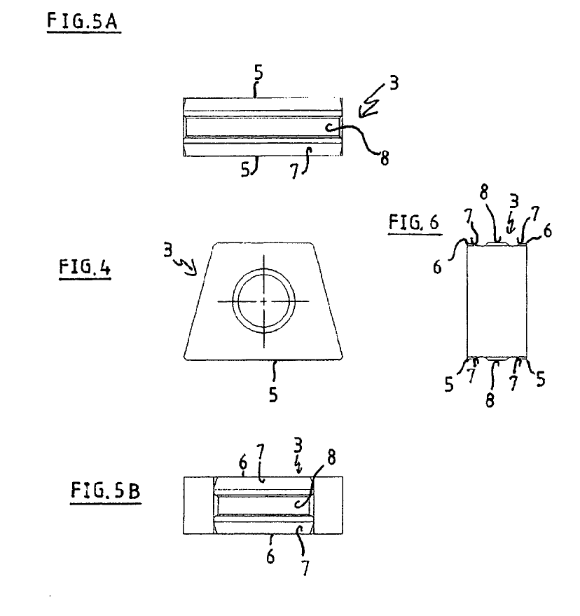

FIG. 4 shows a view from above of an indexable cutting plate according to the invention,

FIGS. 5a and 5b show side views of the indexable cutting plate according to the invention, and

FIG. 6 shows a side view in section of the indexable cutting plate of FIGS. 4 and 5a, 5b.

FIG. 1 shows a three-dimensional view inclinedly from above on to a cassette having four cutting inserts for a crankshaft milling cutter. A milling cutter axis 30 extends at a radial spacing R relative to a peripheral surface jointly defined by all active cutting edges 5, 6. The cassette can be fixed to the tool holder of a crankshaft milling cutter. Four receiving means 2 for indexable cutting plates 3 can be clearly seen in the segment of the crankshaft milling cutter, that is illustrated in FIG. 1. In that respect each receiving means 2 comprises a plate seat 4 formed by a flat contact surface. In that respect the configuration of the flat surfaces 4 is such that the surface 4 is arranged at an angle with respect to the tangent of the crankshaft milling cutter at the location of the active cutting edges 5, 6 of the cutting inserts 3, but parallel to the axis 30. In addition each cutting plate holder has a wedge 9 which is fixed to the segment 1 by means of an adjusting screw 10. In the illustrated embodiment the adjusting screw is a finely threaded socket screw.

Each cutting insert 3 is screwed fast to the segment 1 by means of a Torx screw 11. The arrangement of the cutting inserts 3 on the segment or the cassette 1 of the milling cutter can be particularly clearly seen from the side view in FIG. 3. In particular it is possible to see the inclination of the flat surfaces of the plate seats 4 relative to the tangent of the milling cutter at the point of the active cutting edges 5, 6.

The geometrical shape of the indexable cutting plates 3 used is shown in detail in FIGS. 4, 5a and 5b and 6. The plan view of the indexable cutting insert in FIG. 4 clearly shows that the cutting plates are of an equal-sided trapezoidal basic shape. In that case each of the cutting inserts has a total of four cutting edges, two long edges 5 and two short edges 6. The side surfaces adjoining the cutting edges 5, 6 each form a respective chip face 7 for each of the cutting edges. Each of the chip faces 7 is provided in the form of a concave depression in the side surfaces and in use of the indexable cutting plate serves as a chip removal face and thus for chip formation. Provided between two adjacent chip faces 7, for example the long upper and lower cutting edges 5, is a land 8 which forms a raised contact surface in relation to the concave depressions of the chip faces 7. In that respect the surface 8 of the land in the illustrated embodiment is at a somewhat greater spacing from the lowest point of the chip faces 7, than the plane of the cutting edges 5 and 6 respectively.

In the illustrated embodiment the trapezium angle of the cutting insert is 15°, the length of the base side is 14 mm and the width (defined as the spacing between the base side and the short side) is 8.5 mm. The thickness of the cutting insert is 5 mm. The milling cutter is 700 mm in diameter and is provided for accommodating 48 cutting inserts.

The mode of operation involved in the co-operation between the plate holders 2 according to the invention and the indexable cutting plates 3 can be particularly clearly seen from FIGS. 2 and 3. In that case FIG. 2 shows a view from above of the segment 1, shown in FIG. 1, of the crankshaft milling cutter according to the invention. The radial spacing of the active cutting edges 5, 6 of the indexable cutting plates 3 can be adjusted by means of the inclined plate seats 4 and the adjustable wedges 9. In that case the Torx screw 11 has sufficient lateral play so that fine adjustment of the cutting inserts 3 is possible in spite of the screw 11. The wedges have an abutment surface 12 which is inclined with respect to their direction of movement. The inclusion of an angle between the direction of movement of the wedges 9 and the abutment surface 12 means that the position of the abutment surface 12 is altered in the peripheral direction by translation of the wedge 9.

The land 8 of each cutting insert 3 bears against the abutment surface 12 of the corresponding wedge 9. If now the position of the abutment surface 12 changes in the peripheral direction then the position of the cutting insert 3 accommodated in the respective plate holder 2 also changes in the peripheral direction. As the plate seat or the flat surface 4 thereof is inclined with respect to the tangent of the milling cutter at the location of the cutting edge 5, 6, that displacement of the indexable cutting plate 4 in the peripheral direction leads to a change in the radial spacing of the cutting edge 5, 6 from the axis of rotation of the crankshaft milling cutter.

In the illustrated embodiment the inclination of the flat surface 4 is 12° with respect to the tangent at the point of the active cutting edge.

As the upper and lower surfaces of the cutting insert are of mirror-image configuration in mutually parallel relationship the inclination of the seat surface 4 with respect to a tangent at the same time defines the required clearance angle.

In the installed condition only one cutting edge 5, 6 of each cutting insert 3 is active in each case, that is to say it comes into engagement with the workpiece. When the service life of the cutting edge, for example the short cutting edge 6 of the left-hand cutting insert in FIG. 2, is reached, the indexable cutting plate can be turned so that the second, initially downwardly disposed, short cutting edge 6 becomes the active cutting edge. When the service life of the second short cutting edge 6 is also reached, the trapezoidal indexable cutting plates 3 of the crankshaft milling cutter are interchanged, between adjacent cutting plate holders 2 of the milling cutter. For example the two left-hand indexable cutting plates 3 in FIG. 2 are interchanged with each other. Thereafter, the two long cutting edges 5 of the left-hand cutting insert 3 successively become the active cutting edge on the right-hand cutting plate holder 2 and the short cutting edges 6 of the right-hand one of the two illustrated cutting inserts 3 become active cutting edges on the left-hand one of the two illustrated cutting plate holders 2.

In the region of the cutting edges the plate seat has a depression in the flat surface 4 so that the cutting edges do not come into engagement with the plate seat.

The use of four cutting edges on the indexable cutting plates 3 in succession is possible by virtue of the fact that the indexable cutting plates are supported by means of the lands 8 against the abutment surfaces 12 of the wedges. As a result the cutting edges 5, 6 do not come into contact even in the installed condition with the cutting plate holder 2, that is to say neither with the wedge 9 nor with the flat surface 4, so that the cutting edges only experience a loading and suffer wear when they come into engagement as active cutting edges with the workpiece. The seat surface 4 therefore desirably has a relief undercut (not shown) in the region of the abutment surface 12 of the wedge 9.

In the illustrated embodiment the geometrical arrangement of the wedge 9 permits an adjustment range of the cutting edge of 0.05 mm, thereby permitting adjustment of the rotary truth of the milling cutter of less than 0.005 mm.

In the illustrated preferred embodiment of the invention the cutting inserts 3 are trapezoidal so that, upon a displacement of the cutting inserts 3 in the peripheral direction, a side surface always remains parallel to the side surfaces 13 of the milling cutter (or the cassette). For that purpose the angle included between the abutment surface 12 of the wedge 9 and the side surface 13 of the milling cutter is equal to the large angle of the trapezium described by the upper and lower surfaces of the cutting inserts 3.

In alternative embodiments however the inclination of the abutment surfaces 12 of the wedges 9 can be such that the side surfaces of the cutting inserts 3 include a clearance angle of preferably 2° relative to the side surfaces 13 of the milling cutter, that are perpendicular to the axis of rotation.

In the illustrated embodiment the full cutting width of the crankshaft milling cutter is achieved by the co-operation of two respective peripherally adjacent cutting inserts 3. It can be clearly seen for example from FIG. 2 that just by the co-operation of a respective short cutting edge 6 and a long cutting edge 5 of two cutting inserts 3 a milling cutter cutting width is achieved which approximately corresponds to the width of the cassette or is slightly wider than same. For that purpose, as considered in the peripheral direction, a short cutting edge 6 and a long cutting edge 5 of adjacent inserts 3 respectively overlap. The active cutting edges 5, 6 of the cutting inserts 3 are inclined with respect to the axis of rotation of the milling cutter in the illustrated embodiment so that the individual portions of each cutting edge 5, 6 successively come into engagement with the workpiece. In that way the force acting on each cutting insert at a given moment is reduced.

Even hardened shafts can be machined with the crankshaft milling cutter according to the invention.

As the cutting edges are also slightly inclined because of the inclination of the wedge surfaces 12, with respect to the axis 30, the cutting edges can be of a slightly cambered configuration so that they are disposed exactly in a (common) cylindrical surface.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

### List of References

1 milling cutter, milling cutter segment, cassette
2 cutting plate holder, receiving means
3 indexable cutting plate, cutting insert
4 plate seat, flat surface
5, 6 cutting edge
7 chip face
8 land
9 wedge
10 adjusting screw
11 Torx screw
12 abutment surface
13 side surface
30 cutting milling axis

1. A method of machining bearing journals, comprising a first step for rough machining and a second step for fine machining, wherein in the first step the journal is roughed with a crankshaft milling cutter and in the second step the journal is smoothed with a crankshaft milling cutter, wherein the fine machining method exclusively comprises the second step which concludes the dimension-changing machining of the bearing journals.

2. A method according to claim 1, wherein the method has precisely the two steps of roughing milling and smoothing milling.

3. A method according to claim 1, wherein an outside periphery of the journal is substantially defined with the first step.

4. A method according to claim 1, wherein the second step of smoothing milling operation is effected with a cutting speed of more than 250 m/min.

5. A method according to claim 1, wherein the second step of smoothing milling operation is effected with an advance speed of 1000 mm/min to 2000 mm/min.

6. A method according to claim 1, wherein the smoothing milling operation concludes the machining of the bearing journals with an averaged roughness depth of a surface of the bearing journals of less than or equal to 3.2 μm.

7. A method according to claim 1, wherein the bearing journals are machined.

8. A method according to claim 7, the journals of the main bearings are machined.

9. A method according to claim 7, wherein the journals of the crank bearings are machined.

10. A method according to claim 1, wherein a milling cutter or a milling cutter segment is used, the milling cutter or a milling cutter segment rotatable about a milling cutter axis for smoothing machining of bearing journals with at least one cutting plate holder,
wherein the cutting plate holder has a first flat surface forming a part of the plate seat and a displaceable wedge for adjusting a radial spacing of a cutting edge of a cutting plate from the milling cutter axis,
wherein the wedge has an abutment surface, substantially perpendicular to the flat surface, for a side surface of the cutting plate, and
wherein the wedge is movable in a direction substantially parallel to the flat surface.

11. A method according to claim 10, wherein an indexable cutting plate is used, the indexable cutting plate comprising an upper and a lower surface and peripherally extending side surfaces which connect the upper and lower surfaces together,
wherein edges between the upper and lower surfaces respectively and the side surfaces form the cutting edges,
wherein the side surfaces form chip faces adjoining the cutting edges,
wherein the chip faces of the upper and lower cutting edges are separated by a land which protrudes with respect to the chip faces, and
wherein the land forms a lateral contact surface of the cutting insert.

12. A milling cutter or a milling cutter segment which are rotatable about a milling cutter axis, for smoothing machining of bearing journals with at least one cutting plate holder wherein the cutting plate holder has a first flat surface forming a part of the plate seat and a displaceable wedge for adjusting a radial spacing of a cutting edge of a cutting plate from the milling cutter axis, wherein the wedge has an abutment surface, substantially perpendicular to the flat surface, for a side surface of the cutting plate, and wherein the wedge is movable in a direction substantially parallel to the flat surface.

13. A milling cutter according to claim 12, wherein the cutting plate holder is adapted to receive trapezoidal cutting inserts.

14. A milling cutter according to claim 13, wherein the milling cutter has a plate seat of a first type which is so designed that it receives a cutting insert in such a way that a cutting edge of a long base side of the trapezium comes into engagement with a workpiece and a plate seat of a second type which is so designed that it receives the cutting insert in such a way that a cutting edge of a short side of the trapezium, that is parallel to a base side, comes into engagement with the workpiece.

15. A milling cutter according to claim 12, wherein the abutment surface of the wedge is arranged at an angle to the axis of rotation of the milling cutter.

16. A milling cutter according to claim 12, wherein the abutment surface of the wedge is arranged at an angle of 5°-10° relative to the direction of movement of the wedge.

17. A milling cutter according to claim 12, wherein the wedge, a wedge angle and an inclination of the seat surface are so dimensioned that they permit an adjustment range of the cutting edge of the cutting plate in the radial direction with respect to the milling cutter axis of 0.05 mm.

18. A milling cutter according to claim 12, wherein the wedge permits an adjustment of the rotary truth of less than 0.005 mm.

19. A milling cutter according to claim 12, wherein two respective adjacent cutting plate holders are so arranged that the cutting plates receivable therein overlap each other considered in the direction of rotation of the milling cutter.

20. A milling cutter according to claim 12, wherein the abutment surface of the wedge in a direction perpendicular to the flat surface of the plate seat is of a width of 0.5 mm to 5 mm.

21. An indexable cutting plate for a milling cutter for smoothing machining of bearing journals comprising an upper and a lower surface and peripherally extending side surfaces which connect the upper and lower surfaces together, wherein the edges between the upper and lower surfaces respectively and the side surfaces form the cutting edges, wherein the side surfaces form chip faces adjoining the cutting edges, wherein the chip faces of the upper and lower cutting edges are separated by a land which protrudes with respect to the chip faces, wherein the land forms the lateral contact surface of the cutting insert.

22. An indexable cutting plate according to claim 21, wherein the upper and the lower surfaces have at least one corner with an angle of greater than 90°.

23. An indexable cutting plate according to claim 21, wherein the upper and the lower surfaces are substantially trapezoidal.

24. An indexable cutting plate according to claim 21, wherein the indexable cutting plate has four cutting edges which extend along parallel sides of the cutting insert.

25. An indexable cutting plate according to claim 21, wherein a surface of the land is outside a plane defined by the cutting edges of a side of the cutting insert.

26. An indexable cutting plate according to claim 25, wherein the surface of the land projects with respect to the plane by 0.01 mm to 0.5 mm, preferably by 0.05 mm.

27. An indexable cutting plate (3) according claim 21, wherein the cutting edges (5, 6) are provided with a PVD Al₂O₃ coating as the cutting material.

28. An indexable cutting plate according to claim 21, wherein the indexable cutting plate has a concave chip face for chip formation.

29. Use of a milling cutter according to claim 12, for smoothing machining of bearing journals of a crankshaft.

30. Use according to claim 29 wherein the an indexable cutting plate is used,
wherein the indexable cutting plate comprises an upper and a lower surface and peripherally extending side surfaces which connect the upper and lower surfaces together,
wherein the edges between the upper and lower surfaces respectively and the side surfaces form the cutting edges,
wherein the side surfaces form chip faces adjoining the cutting edges,
wherein the chip faces of the upper and lower cutting edges are separated by a land which protrudes with respect to the chip faces, wherein the land forms the lateral contact surface of the cutting insert.
